(19) United States
(12) Patent Application Publication
(10) Pub. No.: US 2026/0044036 A1
(43) Pub. Date: Feb. 12, 2026

(54) METHOD FOR MANUFACTURING A LIQUID CRYSTAL DISPLAY DEVICE FOR A TIMEPIECE

(71) Applicant: The Swatch Group Research and Development Ltd, Marin (CH)

(72) Inventor: Michel SAGARDOYBURU, Neuchâtel (CH)

(73) Assignee: The Swatch Group Research and Development Ltd, Marin (CH)

(21) Appl. No.: 19/225,083

(22) Filed: Jun. 2, 2025

(30) Foreign Application Priority Data
Aug. 8, 2024 (EP) 24193706.9

(51) Int. Cl. G02F 1/1335; G02F 1/1343; G04G 9/00

(52) U.S. Cl. CPC G02F 1/133528; G02F 1/13439; G04G 9/0064; G02F 2202/28; G02F 2203/01

(57) ABSTRACT

A method for manufacturing a liquid crystal cell (LCD cell), forming a horology display device, includes the formation of a base assembly (32), including the two transparent plates on which the electrodes (28, 29) are structured, and a cover assembly (66) including a useful part (50) formed by a polariser and a layer of glue for fastening the polariser to one of the transparent plates. To deposit the polariser precisely, targets (30a, 30c) are made in the base assembly and corresponding alignment marks (48a, 48c) are blanked in at least one working part of the cover assembly, such that the targets can be seen through the alignment marks when the cover assembly is placed on the base assembly when the polariser is glued to this base assembly.

### CROSS-REFERENCE TO RELATED APPLICATIONS

This application claims priority to European Patent Application No. 24193706.9 filed on Aug. 8, 2024, the entire contents of which are incorporated herein by reference.

### TECHNICAL FIELD OF THE INVENTION

The present invention relates to the field of manufacturing liquid crystal display devices (also referred to as “LCD devices”) for timepieces, in particular liquid crystal cells (also referred to as “LCD cells”) defining a display zone on only part of the visible zone of the LCD cell once the LCD device has been arranged in a watchcase. In particular, such an LCD cell is provided to obtain an electronic display above a dial with a display zone partially covering the part of the dial that is visible to a user, in particular an electronic display located above an analogue display device of the watch and having a transparent zone (zone of the LCD cell without a polariser) about the display zone (zone of the LCD cell with polarisers and electrodes), so as to obtain a floating-type electronic display.

### TECHNOLOGICAL BACKGROUND

Document EP 3 650 958 describes a watch fitted with an electro-optical device having a “floating” electronic display, a transparent zone through the electro-optical cell being at the periphery of a display zone of this electro-optical cell (LCD cell). It is provided in this document that the display zone, defining an upper electronic display, is opaque, in contrast to the transparent peripheral zone (the zone without a polariser), such that a dial and a lower analogue display, located below the LCD cell, remain constantly invisible in the display zone and visible in the transparent peripheral zone.

In particular, the display zone is defined by a rear polariser and a front polariser that overlap and are provided only over a part of the LCD cell region visible in the watch to a user. In other words, the polarisers extend over a surface of the LCD cell that is smaller than the useful surface of this LCD cell (visible surface of the LCD cell when incorporated in the watch), the LCD cell extending, in a general plane, over a surface comprising the entirety of a window of this watch provided such that said analogue display and said electronic display can be seen, this window defining a useful zone/visible zone of the liquid crystal cell.

One major problem with “floating” electronic displays as described above arises from the fact that the polarisers have dimensions smaller than those of said window, such that the slightest offset between the front polariser and the rear polariser is clearly visible at the edge of the LCD cell display zone. Indeed, a small offset between two overlapping circular polarisers produces a silvery crescent, more or less fine depending on the offset, which is clearly visible to the user. This gives an impression of low-end manufacture, as would a poorly made colour print, for example with a succession of base colour prints that are offset, in other words not precisely aligned.

There is thus a need for a method for manufacturing LCD cells with a “floating” display zone, which enables precise alignment of the front and rear polarisers and also precise positioning of these two polarisers relative to the electrodes that define the information that can be displayed. More generally, a method is sought for positioning a polariser in the liquid crystal cell that only partially covers the useful zone/visible zone of the liquid crystal cell.

### SUMMARY OF THE INVENTION

To address the major problem and meet the need identified in the technological background, the invention generally relates to a method for manufacturing a liquid crystal display device as defined in claim 1. A main method for implementing the manufacturing method is defined in claims 1 and 7. An LCD display device for which the main implementation method is highly advantageous is defined in dependent claim 8. Advantageous variants are defined in claims 9 and 10.

Using the characteristics of the manufacturing method according to the invention, a polariser can be positioned very precisely on a transparent plate of the liquid crystal cell. In particular, a polariser, only partially covering the useful zone/visible zone of this liquid crystal cell, can be precisely positioned in this useful zone/visible zone and relative to the electrodes. As the manufacturing method according to the invention can be made for a front polariser and repeated for a rear polariser, perfect alignment of these two polarisers can be obtained, particularly in the case of a “floating” display.

### BRIEF DESCRIPTION OF THE FIGURES

The invention will be described in detail below with reference to the appended drawings, which are given by way of non-limiting examples, in which:

FIG. 1 is a plane view of a transparent plate, on which electrodes are structured in a display zone and at its periphery, this transparent plate being designed to form a liquid crystal cell (also referred to as an “LCD cell”) used in a method for implementing the manufacturing method according to the invention;

FIG. 2 is a cross-sectional view through a base assembly of the LCD cell being manufactured;

FIG. 3 is a cross-sectional view, along line III-III in FIG. 5, of an initial assembly comprising a polariser film, one part of which is designed to form a polariser only partially covering a useful zone/visible zone of the LCD cell, this initial assembly undergoing a specific blanking operation;

FIG. 4 schematically shows the removal of a residual part from the initial assembly, such that the parts of the polariser film useful for the rest of the manufacturing method are retained;

FIG. 5 is a top view of an intermediate assembly obtained from the initial assembly after the residual part has been removed;

FIG. 6 shows a cross-sectional view, along line VI-VI of FIG. 5, of a transfer of parts of the intermediate assembly, located on a rest forming this intermediate assembly, to an additional rest to form a final assembly ready for deposit of the polariser on the transparent plate of the base assembly;

FIG. 7 shows the precise positioning of the final assembly relative to the base assembly before the polariser is glued to the upper transparent plate of the base assembly;

FIG. 8 is a cross-sectional plane view along line VIII-VIII in FIG. 7;

FIG. 9 is a cross-sectional view of the partially formed LCD cell with the front polariser glued to the base assembly; and

FIG. 10 is a cross-sectional view of the fully formed LCD cell with a rear polariser deposited on the lower transparent plate of the base assembly in the same manner as the front polariser.

### DETAILED DESCRIPTION OF THE INVENTION

A method for implementing the method for manufacturing a liquid crystal cell/LCD cell according to the invention is described in detail below.

After said implementation of the manufacturing method, the liquid crystal display device comprises a liquid crystal cell 2 (FIG. 10), which is formed by a first plate 4 and a second plate 6, which are transparent, and by a bead of glue 8 connecting the first and second plates and defining therewith a closed space containing liquid crystals 10, the liquid crystal cell defining, inside the bead of glue, a useful zone 12, which is designed to define the visible zone of this cell in a timepiece for which the display device is designed, and comprising in this useful zone a first polariser 14 and a second polariser 16 which are respectively deposited on the outer surface 5 of the first plate 4 and on the outer surface 7 of the second plate 6 using a first layer of glue 18 and a second layer of glue 20 which ensure that the first and second polarisers are fastened and held in place. In the field of LCD cells, each of the two transparent plates on which electrodes are printed or structured on one side and which support a polariser on the other side is also referred to as a “substrate.” In the advantageous variant described, the first polariser and the second polariser are arranged precisely facing each other, and the first and second polarisers only partially cover the useful zone 12. In this advantageous variant, the LCD display is designed to be “floating” in a display zone 24 provided at the centre of the LCD cell 2, this display zone being defined by the first and second polarisers.

Electrodes are made on the inner surface of the first plate, respectively of the second plate, in particular in a zone 26 of the useful zone 12, this zone 26 incorporating the display zone 24. The two electrode assemblies 28 and 29, shown in continuous cross-section given the dimensions of the drawing, are located facing each other in the closed space containing the liquid crystals 10. Generally speaking, in the context of the invention, the first polariser and the second polariser are arranged at least partly facing each other such that at least the first polariser only partially covers the useful zone 12. Thus, in a general implementation method, the second polariser can completely cover the useful zone, such that this second polariser does not need to be precisely positioned relative to the first polariser and/or relative to the electrodes of the LCD cell. It should be noted that the LCD cell may have other polarizers arranged on the outer surface of the first plate 4, these other polarizers defining other display zones or decorative zones arising from the selected polarizers. Preferably, these other polarisers are also deposited by the manufacturing method according to the invention. It should be noted that the first polariser 14 and the second polariser 16 can respectively be a front polariser and a rear polariser of the LCD cell, or conversely.

The manufacturing method according to the invention relates to the deposit of a polariser only partially covering the useful zone 12. Hereinafter, as part of the description of the advantageous variant of the manufacturing method relating to a “floating” display, the deposit of the first polariser 14 will be described in detail and it will be noted that the deposit of the second polariser 16 is similar to the deposit of the first polariser. The steps involved in depositing the second polariser will therefore not be repeated in detail.

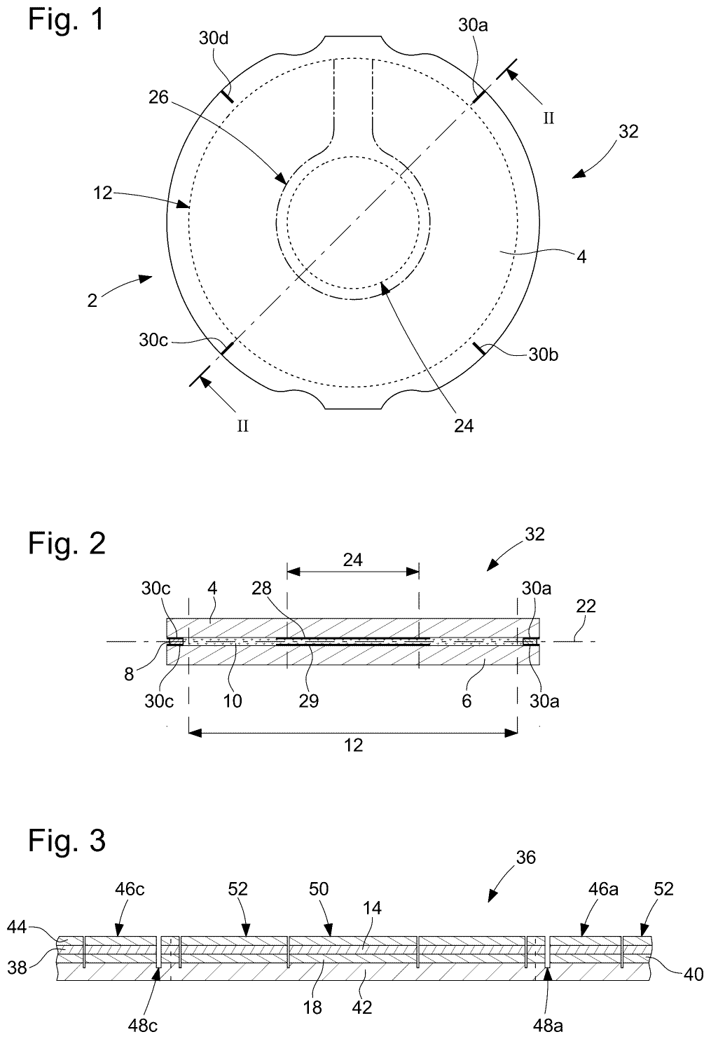

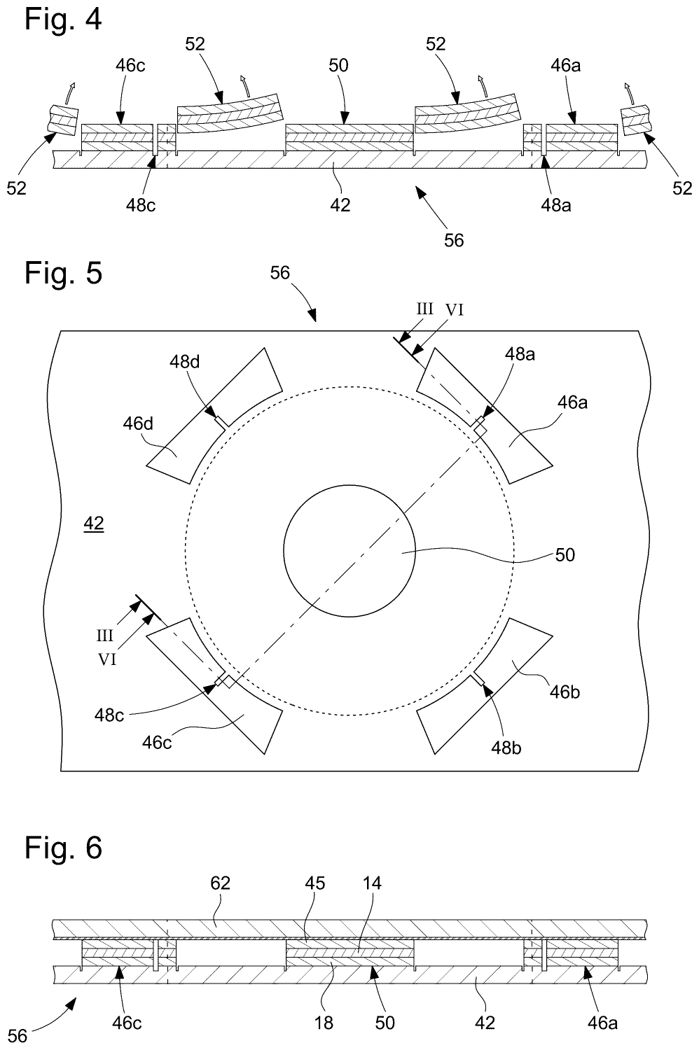

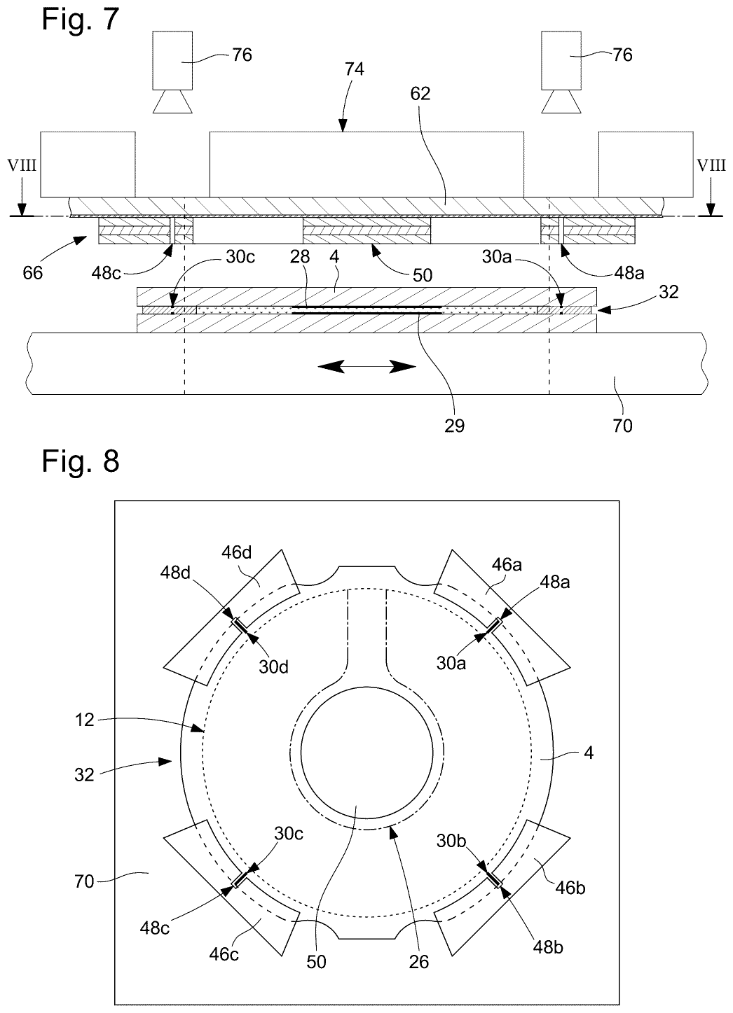

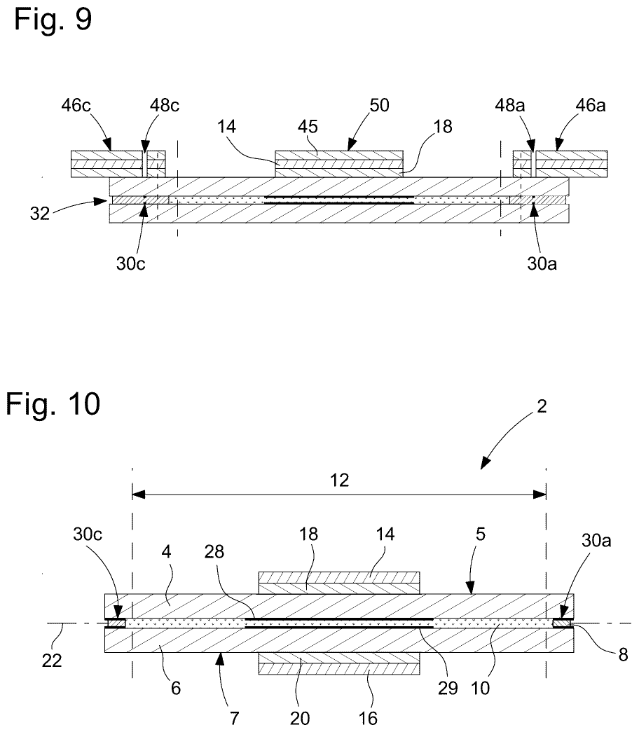

The manufacturing method comprises the following steps:
Step A) Making four targets 30a, 30b, 30c and 30d on the first transparent plate 4, for subsequent deposit of the first polariser 14 (see FIG. 1), and on the second transparent plate 6, for subsequent deposit of the second polariser 16. In particular, the four targets are defined by four relatively thick radial lines printed on the inner surface of the transparent plate in question and offset by 90°. Generally speaking, at least two targets are to be made in this step A). A specific condition as to said at least two targets is given in the following step B).
Step B) Forming a base assembly 32 (see FIG. 2) comprising the first plate 4, the second plate 6, the bead of glue 8 defining said closed space and liquid crystals 10 filling said closed space, targets 30a to 30d being made and this base assembly being formed such that at least two of the targets, spaced apart in orthogonal projection in a general plane 22 of the base assembly, are visible, at least under a given light, from the side of the outer surface 5 of the first transparent plate 4.
Step C) Forming an initial assembly 36 (see FIG. 3) comprising a polariser film 38, an adhesive film 40 deposited on an inner face of the polariser film, and a rest 42 that supports the polariser film and the adhesive film, one part of the polariser film being used to form the first polariser 14 and being covered by a first part 18 of the adhesive film. This first part of the adhesive film is also referred to as the “glue layer” in the LCD cell 2 obtained by the manufacturing method. In the particular embodiment shown in the figures, the initial assembly 36 advantageously also comprises a protective film 44 provided to protect the polariser until the LCD cell is mounted in a watchcase.
Step D) Blanking the initial assembly 36 (see FIG. 3), from the side opposite to the rest 42, so as to pass through the polariser film 38 and the adhesive film 40, while defining the perimeter of a useful part 50, situated on the rest and comprising the first polariser 14 and said first part 18 of the adhesive film, and four working parts 46a, 46b, 46c and 46d, but without passing through the rest 42. It should be noted that in a general variant, at least one working part is provided. Four alignment marks 48a, 48b, 48c and 48d are also blanked in the four working parts respectively. The latter blank can be either a blind hole, meaning that it does not pass through the rest 42, or a through hole. The four alignment marks are blanked such that they have relative positions between them which are identical to the relative positions of the four targets 46a to 46d printed on the first plate 4 of the base assembly 32. It should be noted that in the case of the particular variant with the protective film 44, the latter is also blanked in all the planned blanks. The useful part 50 thus comprises an upper part 45 which is blanked out of the protective film 44. More generally, all of the films located above the rest 42 are blanked during this blanking step. In the variant shown, the working parts comprise part of the adhesive film 40, part of the polariser film 38 and part of the protective film 44. It should be noted that the working parts advantageously have parts of the same films forming the useful part 50, in particular respective parts of the polariser film.
   In the general variant, at least two alignment marks are machined at least through said at least one working part, such that these at least two alignment marks have relative positions between them which are identical to the relative positions of said at least two targets. The various blanks can be made using a laser beam, a blade or any other suitable blanking method. The rest 42 is arranged so that it can maintain an initial relative position between the useful part 50 and the working parts 46a to 46d right from this blanking step.
Step E) Removing from the initial assembly 36, after the blanking step D), a residual part 52, located on the rest 42, which is complementary to said useful part 50 and to the working parts (more generally to said at least one working part), while leaving said useful part and these working parts (more generally said at least one working part) in place on the rest, such that, in the case where the rest 42 is located on the side opposite to the polariser film 38 relative to the adhesive film 40 (case corresponding to the implementation method described with reference to the Figures), an intermediate assembly 56 is obtained (see FIGS. 4 and 5) or, in the other case, a first final assembly.
   If the rest is located, in the initial assembly, on the side opposite to the adhesive film relative to the polariser film and step E) provides the first final assembly incorporating the rest, this rest is designed to be transparent, at least under said given light, or open in at least two zones respectively overlapping said at least two alignment marks. This situation relates to another method for implementing the method for manufacturing an LCD display device according to the invention, which is dealt with in this description only insofar as it departs from the implementation method which is described with reference to the Figures.
Step F) In the case where step E) provides the intermediate assembly 56 (as in the implementation method shown), adding an additional rest 62, on the side of the first polariser 14 which is opposite to the first part 18 of the adhesive film; and transferring the first polariser with said first part of the adhesive film and said at least one working part, in particular the four working parts of the variant shown, from the rest 42 onto the additional rest 62 to form a second final assembly 66. The additional rest 62 is transparent (variant of FIGS. 6 and 7), at least under said given light, or open in zones respectively overlapping said alignment marks 48a to 48d. Next, the additional rest 62 is arranged to be able to maintain said initial relative positioning between the first polariser 14 and the working parts 46a to 46d.

The previous steps are followed by the following successive steps:
Step G) Adding, as the case may be, said first final assembly or said second final assembly 66 (implementation method shown) above the first plate 4 of the base assembly 32, using a tool 74 which is transparent, at least under said given light, or open (variant of FIG. 7) in zones overlapping the alignment marks 48a to 48d with the rest, respectively the additional rest 62 (implementation method shown) located on the side opposite to the first plate relative to the working parts (more generally, to said at least one working part) and the first part 18 of the adhesive film 40 located directly facing the first plate (see FIG. 7); and precisely positioning, as the case may be, the first final assembly or second final assembly 66 relative to the first plate 4 by precisely aligning the targets 30a to 30d (more generally, said at least two targets) with said alignment marks 48a to 48d, respectively (more generally, said at least two alignment marks), using a table 70 that can be moved in a plane parallel to the general plane 22 of the base assembly 32 and an optical device 76 arranged to make it possible to see, at least under said given light (in particular collimated blue light) and in a direction orthogonal to the general plane, said targets through said alignment marks, which are arranged such that the targets can be precisely aligned, in said orthogonal direction, respectively, with those alignment marks (see FIG. 8).
Step H) Moving, in the direction orthogonal to said general plane, the first final assembly, respectively the second final assembly 66, towards the first plate 4 of the base assembly; gluing the first polariser 14 to this first plate using said first part 18 of the adhesive film; and removing the rest, respectively the additional rest 62. In the advantageous variant of the method described, the working parts each comprise part of the adhesive film and are also glued to the first plate 4 simultaneously with the first polariser. In a first variant, the working parts are provided outside the useful zone 12 and can be left on the first plate 4 in the LCD cell.

In a second variant, the working parts are removed following step H), in particular when they extend beyond the outer outline of the transparent plate to which they are glued or are located at least partly in the useful zone 12.

The manufacturing method is repeated for the deposit of the second polariser 16, which only partially covers the useful zone 12 and, in the advantageous variant shown in the figures, has the same dimensions as the first polariser 14 and overlaps this first polariser entirely. Thus, the initial assembly 36 is a first initial assembly and the manufacturing method further comprises a step of forming a second initial assembly, similar to the first initial assembly, comprising a second polariser film, a second adhesive film deposited on an inner face of the second polariser film, and a second rest supporting the second polariser film and the second adhesive film, part of the second polariser film being designed to constitute the second polariser 16 and being covered by part 20 of the second adhesive film. Generally speaking, said targets are made and said base assembly 32 is formed such that at least two of the targets, spaced apart in orthogonal projection in said general plane 22, are visible, at least under the given light, from the side of the outer surface of the second plate 6. In the particular embodiment shown in the figures, four targets 30a to 30d are printed on the inner face of the second transparent plate 6. They can be aligned, in said orthogonal direction, with the four targets printed on the first transparent plate 4. Steps D) through H) are repeated with the second initial assembly. The end result is the liquid crystal cell 2 shown in FIG. 10.

According to a particular variant, the first polariser has, at least in part of the useful zone 12, a first outline which is identical to the second outline of the second polariser, the first outline and the second outline being precisely aligned in the direction orthogonal to the general plane 22 in the liquid crystal cell 2.

In another particular variant, the first polariser and the second polariser are located entirely within the useful zone.

According to the advantageous variant shown in the figures, the first polariser 14 and the second polariser 16 form a “floating” display in the timepiece for which the display device is designed, the first polariser and the second polariser having the same dimensions and completely overlapping each other within the useful zone.

Regarding step A), in a variant of the implementation method described in which the targets can be seen, at least under a given light, from outside the two sides of said base assembly, targets can only be provided on the first plate 4 or on the second plate 6 for depositing the first polariser 14 and the second polariser 16. In the general implementation method where only the first polariser only partially covers the useful zone 12, the targets are preferably deposited on the inner surface of the first plate.

In a preferred variant, the liquid crystal cell comprises electrodes (electrode assemblies 28 and 29) which are transparent in the visible field and are made of a conductor material enabling at least the outline thereof to be seen under said given light, the targets 30 being made with said conductor material on the first plate and/or the second plate simultaneously when structuring the transparent electrodes. The targets 30 can thus be positioned very precisely relative to the electrode assembly on the inner surface of the transparent plate in question. In particular, the conductor material is indium tin oxide (ITO), which is a mixture of indium oxide In2O3 and tin oxide SnO2.

In a preferred variant, the targets 30 are arranged outside the useful zone 12. This variant is even desirable when the targets are printed with ink that is visible to the user.

In general, the bead of glue 8 connecting the first and second transparent plates is not sufficiently transparent to allow a target to be seen through this bead of glue. Thus, when a target completely overlaps the bead of glue, this target is generally only useful for depositing a polariser on the transparent plate on which this target is printed. Similarly, when a target mostly overlaps the glue bead, this target is advantageously used only for depositing a polariser on the transparent plate on which this target is printed. Preferably, each target made of ITO has at least one part that does not overlap the bead of glue, as it is relatively difficult to discern the target under said given light with the glue as a backdrop. Moreover, said part that does not overlap the bead of glue is preferably located on the outside of the bead of glue. In fact, the presence of liquid crystals as a backdrop behind a target made of ITO attenuates the target's visibility under said light (particularly blue light). It is therefore advantageous for at least part of the target to be situated outside the bead of glue 8, projected in the general plane 22 of the base assembly 32 (which is also the general plane of the LCD cell 2).

1. A method for manufacturing a liquid crystal display device comprising a liquid crystal cell (2) formed from a first plate (4) and from a second plate (6), which are transparent, and from a bead of glue (8) connecting the first and second plates and defining therewith a closed space containing liquid crystals (10), the liquid crystal cell defining within the bead of glue a useful zone (12), which is designed to define the visible zone of this cell in a timepiece for which the display device is designed, and comprising in this useful zone at least a first polariser (14) and a second polariser (16) which are arranged at least partly facing each other, respectively on the outer surface (5) of the first plate and on the outer surface (7) of the second plate, such that at least the first polariser only partially covers said useful zone; the manufacturing method comprising the following steps:
A) Making targets (30a to 30d) on the first plate and/or on the second plate;
B) Forming a base assembly (32) comprising the first plate, the second plate, the bead of glue defining said closed space and liquid crystals filling this closed space, said targets being made and the base assembly being formed such that at least two of said targets, spaced apart in orthogonal projection in a general plane of this base assembly, are visible, at least under a given light, from the side of the outer surface (5) of the first plate;
C) Forming an initial assembly (36) comprising a polariser film (38), an adhesive film (40) deposited on an inner face of the polariser film, and a rest (42) that supports the polariser film and the adhesive film, one part of the polariser film being used to form the first polariser (14) and being covered by a first part (18) of the adhesive film;
D) Blanking the initial assembly (36), from the side opposite the rest, so as to pass through the polariser film and the adhesive film, while defining the rim of a useful part (50), located on the rest (42) and comprising the first polariser and the first part of the adhesive film, and at least one working part (46a to 46d) located on the rest, but without passing through this rest; and
blanking at least two alignment marks (48a to 48d) at least through said at least one working part, such that said at least two alignment marks have relative positions between them that are identical to the relative positions of said at least two targets, the rest (42) being arranged such that it can maintain an initial relative positioning between said useful part (50) and said at least one working part from this blanking step; the rest being transparent, at least under said given light, or open in at least two zones overlapping said at least two alignment marks when this rest is located, in the initial assembly, on the side opposite to the adhesive film relative to the polariser film;
E) Removing from the initial assembly (36), after the blanking step D), a residual part (52), located on the rest, which is complementary to said useful part (50) and to said at least one working part (46a to 46d), while leaving said useful part and said at least one working part in place on the rest, so as to obtain, in the case where the rest is located on the side opposite the polariser film relative to the adhesive film, an intermediate assembly (56) or, in the other case, a first final assembly;
F) In the case where step E) provides said intermediate assembly (56), adding an additional rest (62), on the side of the first polariser (14) which is opposite said first part (18) of the adhesive film; and transferring the first polariser with said first part of the adhesive film and said at least one working part from the rest onto the additional rest to form a second final assembly (66), the additional rest being transparent, at least under the given light, or open in at least two zones respectively overlapping said at least two alignment marks, the additional rest being arranged to be able to maintain said initial relative positioning between the first polariser and said at least one working part;
these steps being followed by the following successive steps:
G) Adding, as the case may be, the first final assembly or the second final assembly (66) above the base assembly (32) on the side of the first plate (4) with the rest, respectively the additional rest (62) located on the side opposite the first plate relative to said at least one working part and said first part of the adhesive film located directly facing the first plate; and
precisely positioning, as the case may be, the first final assembly or the second final assembly (66) relative to the first plate by precisely aligning said at least two targets (30a to 30d) with said at least two alignment marks (48a to 48d), respectively, using an optical device (76) that is arranged so as to be able to see, at least under said given light and in a direction orthogonal to said general plane (22) of the liquid crystal cell, said at least two targets through said at least two alignment marks (48a to 48d), which are arranged such that said at least two targets (30a to 30d) can be precisely aligned, in said orthogonal direction, with said at least two alignment marks, respectively;
H) Moving, in the direction orthogonal to said general plane, the first final assembly, respectively the second final assembly (66), towards the first plate (4); gluing the first polariser (14) to said first plate using said first part (18) of the adhesive film; and removing the rest, respectively the additional rest (62).

2. The manufacturing method according to claim 1, characterised in that the liquid crystal cell (2) comprises electrodes (28, 29) which are transparent in the visible field and formed from a material enabling at least the outline thereof to be seen under said given light, said targets (30a to 30d) being made from said material and formed on the first plate and/or the second plate simultaneously when the transparent electrodes are made.

3. The manufacturing method according to claim 1, characterised in that said targets are arranged outside said useful zone (12).

4. The manufacturing method according to claim 1, characterised in that said at least one working part (46a to 46d) is covered respectively with at least one corresponding part of the adhesive film (40) and is glued to the first plate simultaneously with the first polariser.

5. The manufacturing method according to claim 4, characterised in that said at least one working part (46a to 46d) is provided outside said useful zone (12) and is left on the first plate in the liquid crystal cell.

6. The manufacturing method according to claim 4, characterised in that said at least one working part (46a to 46d) is removed following said step H).

7. The manufacturing method according to claim 1, in which said initial assembly is a first initial assembly and the second polariser (16) only partially covers said useful zone (12); characterised in that said method comprises forming a second initial assembly, similar to the first initial assembly, comprising a second polariser film, a second adhesive film deposited on an inner face of the second polariser film, and a second rest supporting the second polariser film and the second adhesive film, a part of the second polariser film being intended to constitute the second polariser and being covered by a part of the second adhesive film; in that said making of said targets and said forming of said base assembly (32) are carried out such that at least two of said targets, spaced apart in orthogonal projection in said general plane, are visible, at least under the given light, from the side of the outer surface (7) of the second plate (6); and in that steps D) to H) are repeated with the second initial assembly.

8. The manufacturing method according to claim 7, characterised in that the first polariser (14) has, at least in part of said useful zone, a first outline which is identical to the second outline of the second polariser (16), the first outline and the second outline being precisely aligned in said orthogonal direction in the liquid crystal cell (2).

9. The manufacturing method according to claim 8, characterised in that the first polariser (14) and the second polariser (16) are located entirely within said useful zone (12).

10. The manufacturing method according to claim 9, characterised in that the first polariser (14) and the second polariser (16) are located entirely within the useful zone (12) and form a “floating” display zone in the timepiece for which the display device is designed, the first polariser and the second polariser having the same dimensions and entirely overlapping each other.
